(19) United States
(12) Patent Application Publication
(10) Pub. No.: US 2005/0006975 A1
(43) Pub. Date: Jan. 13, 2005

(54) Twin coil claw pole rotor with dual internal fan configuration for electrical machine

(76) Inventors: Michael D. Bradfield, Anderson, IN (US); David A. Fulton, Anderson, IN (US)

Correspondence Address: James J. Merrick;Cantor Colburn LLP, 55 Griffin Road South, Bloomfield, CT, 06002, US

(21) Appl. No.: 10/714,147

(22) Filed: Nov. 14, 2003

Related U.S. Application Data
(60) Provisional application No. 60/485,610, filed on Jul. 7, 2003.

(51) Int. Cl. H02K 1/00

(52) U.S. Cl. 310/232

(57) ABSTRACT

A dynamoelectric machine including a housing defining a drive end and an opposite slip ring end; a stator; a rotor rotatable within the stator, the rotor including more than two flux carrying segments rotatably disposed on a rotor shaft in the housing, each segment having P/2 claw poles, wherein P is an even number; and a rotor assembly including two fans located adjacent to outbound segments defining the rotor and opposite each other disposed inside the housing and mounted concentric with the rotor shaft.

### CROSS REFERENCE TO RELATED APPLICATION

This application claims the benefit of U.S. Provisional Application No. 60/485,610, filed Jul. 7, 2003 the contents of which are incorporated by reference herein in their entirety.

### TECHNICAL FIELD

This application relates generally to an electrical apparatus. More specifically, this application relates to a twin coil rotor for an electrical machine and enhancing output and efficiency of the same. The application also relates to a twin coil rotor for an electrical machine and a system and method to reduce emitted noise, particularly mechanical noise.

### BACKGROUND

Electrical loads for vehicles continue to escalate. At the same time, the overall package size available for the electrical generator continues to shrink. Consequently there is a need for a higher power density system and method of generating on-board electricity.

In addition, it is desired to reduce the underhood noise associated with a three-phase alternating current (AC) produced by an alternator. The three-phase alternating current is rectified into a direct current, which can be stored in a battery of a vehicle or be used directly by the electrical circuit of the vehicle which is supplied with a direct current (DC) voltage. In particular, it is desired to reduce the magnetic noise. In alternators using fan cooling, it is also desired to reduce the mechanical noise associated with such cooling.

### BRIEF SUMMARY OF THE INVENTION

The above discussed and other drawbacks and deficiencies are overcome or alleviated by a dynamoelectric machine including a housing defining a drive end and an opposite slip ring end; a stator; a rotor rotatable within the stator, the rotor including more than two flux carrying segments rotatably disposed on a rotor shaft in the housing, each segment having P/2 claw poles, wherein P is an even number; and a rotor assembly including two fans located adjacent to outbound segments defining the rotor and opposite each other disposed inside the housing and mounted concentric with the rotor shaft.

In an exemplary embodiment, a coil winding is disposed intermediate each of the more than two flux carrying segments, wherein each coil winding is energized providing a first magnetic polarity on outbound claw poles defining the rotor and providing a second polarity opposite the first polarity on claw poles intermediate the outbound claw poles. The two fans include a drive end fan and a slip ring end fan disposed at the drive end and slip ring end, respectively. The drive end fan is configured to axially draw drive end air into the drive end while the slip ring end fan is configured to axially draw slip ring end air into the slip ring end. The drive end is configured to exhaust a first portion of the drive end air radially out of the housing on a first side of the stator corresponding to the drive end, while a second portion of the drive end air is diverted axially through the stator and radially exhausted from the housing on an opposite second side of the stator corresponding to the slip ring end.

### BRIEF DESCRIPTION OF THE DRAWINGS

FIG. 1 is a sectional view of an AC generator incorporating a stator assembly and a twin coil three segment claw pole rotor assembly constructed in accordance with the present invention;

FIG. 2 is a perspective view of the rotor assembly of FIG. 1;

FIG. 3 is a circuit diagram of an exemplary embodiment of a stator assembly of FIG. 1 having a three-phase stator winding in operable communication with corresponding three-phase bridge rectifier and the twin coil rotor assembly; and

FIG. 4 is the sectional view of an AC generator of FIG. 1 illustrating a twin internal fan configuration and airflow resulting therefrom in accordance with an exemplary embodiment.

### DESCRIPTION OF THE PREFERRED EMBODIMENT

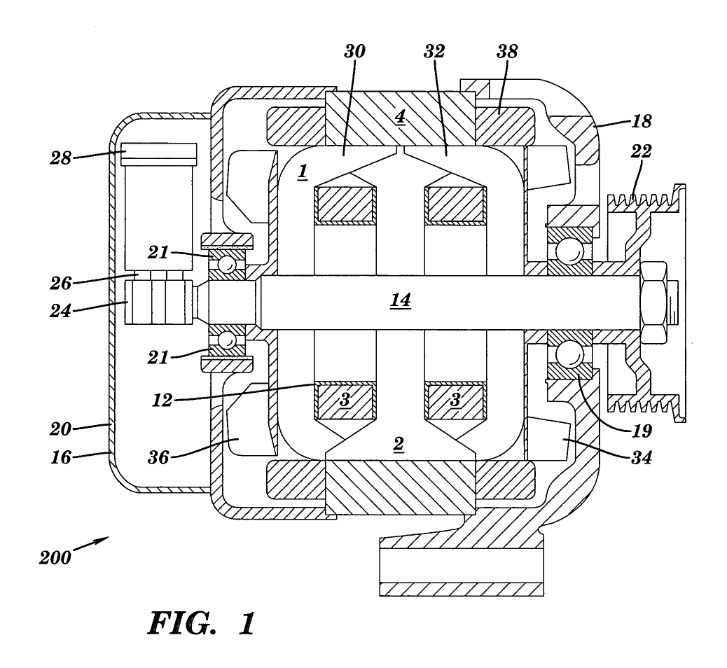

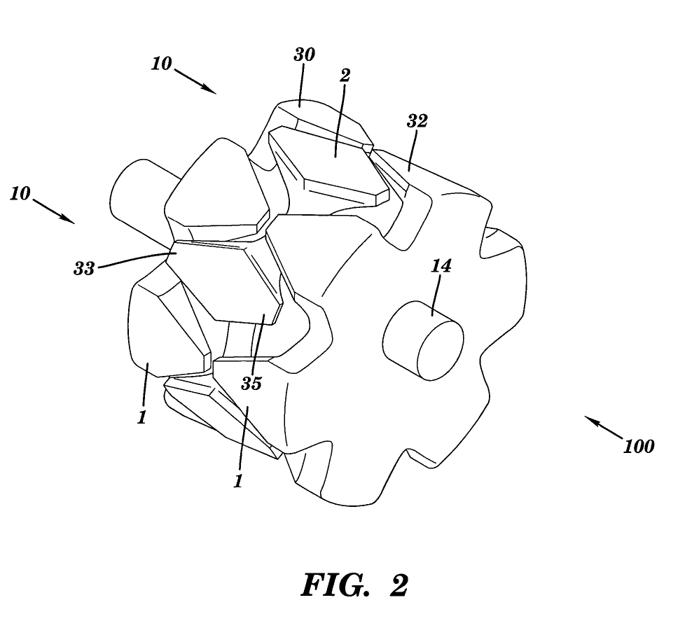

Referring to FIGS. 1 and 2, an exemplary embodiment of a rotor assembly 100 having three claw pole segments is illustrated. The two outbound claw pole segments, or end segments 1, are aligned with each other such that they point towards each other and define a width of the rotor assembly 100. Each end segment 1 has P/2 claw poles where P is an even number and representative of the total number of poles. A third, and center claw pole segment 2 is disposed intermediate end segments 1. Center claw pole segment 2 has poles that project toward the outbound claw pole segments 1 and is typically symmetrical about its center. More specifically, each pole of center claw pole segment 2 extends between a gap 10 created between contiguous claw poles of each end segment 1. Center claw pole segment 2 also has P/2 claw poles where P is an even number corresponding to P for the number of P/2 claw poles of each end segment 1. It will be noted that outbound end claw pole segments 1 are disposed on an outer circumferential edge at a uniform angular pitch in a circumferential direction so as to project axially, and each of the opposing claw pole segments 1 are fixed to shaft 14 facing each other such that the end segment claw-shaped magnetic poles would intersect if they were extended. Furthermore, center claw pole segment 2 is disposed in gap 10 defined by contiguous segments 1 such that a pair of opposing first and second claw-shaped magnetic poles 33 and 35 extending axially defining a circumferential periphery of each center pole segment intermesh with claw-shaped magnetic poles 30 and 32 defining end segments 1.

A field coil winding 3 is located between each end pole segment 1 on a corresponding bobbin 12 for a total of two field coil windings 3. The field coil windings 3 are energized such that the magnetic polarity of the outbound or end pole segments 1 are the same and opposite the center pole segment 2. Such an arrangement for the field rotor produces a stronger rotating magnetic field and allows the axial length of a stator 4 to be more effectively lengthened compared to a claw-pole Lundell alternator. It will be recognized by one skilled in the pertinent art that permanent magnets can be placed between the claw pole segments 1, 2 to further enhance output and efficiency of the stator 4 and rotor assembly 100.

Referring now to FIG. 1, rotor assembly 100 is disposed in a dynamoelectric machine 200 that operates as an alternator in an exemplary embodiment, and is constructed by rotatably mounting a claw-pole rotor or rotor assembly 100 by means of a shaft 14 inside a case 16 constituted by a front bracket 18 and a rear bracket 20 made of aluminum and fixing stator 4 to an inner wall surface of the case 16 so as to cover an outer circumferential side of the rotor assembly 100.

The shaft 14 is rotatably supported in the front bracket 18 via bearing 19 and the rear bracket 20 via bearing 21. A pulley 22 is fixed to a first end of this shaft 14, enabling rotational torque from an engine to be transmitted to the shaft 14 by means of a belt (not shown).

Slip rings 24 for supplying an electric current to the rotor assembly 100 are fixed to a second end portion of the shaft 14, a pair of brushes 26 being housed in a brush holder 28 disposed inside the case 16 so as to slide in contact with these slip rings 24. A voltage regulator (not shown) for adjusting the magnitude of an alternating voltage generated in the stator 4 is operably coupled with the brush holder 28.

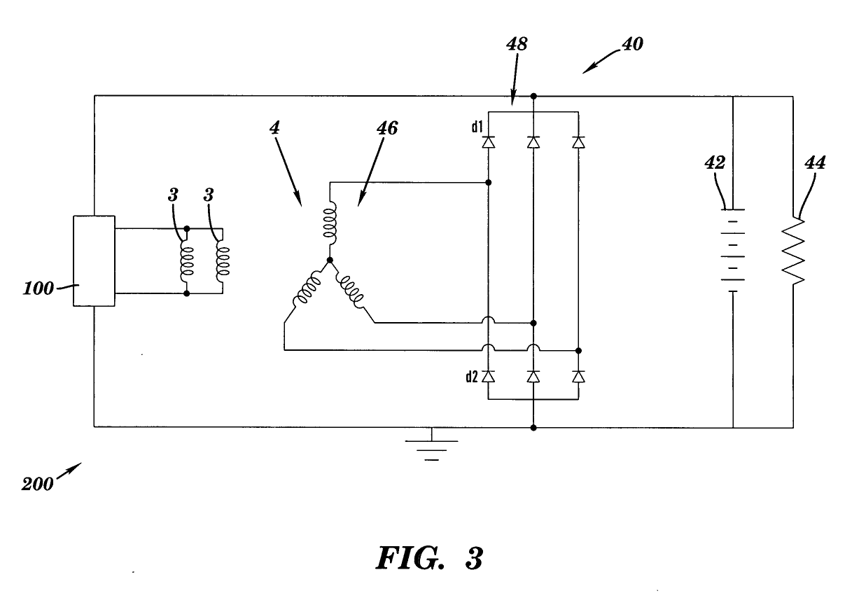

A rectifier 40 (see FIG. 3) for converting alternating current generated in the stator 4 into direct current is mounted inside case 16, the rectifier 40 being constituted by a three-phase full-wave rectifier in which three diode pairs, respectively, are connected in parallel, each diode pair being composed of a positive-side diode d₁ and a negative-side diode d₂ connected in series (see FIG. 3). Output from the rectifier 40 can be supplied to a storage battery 42 and an electric load 44.

As described above, the rotor assembly 100 is constituted by: the pair of field windings 3 for generating a magnetic flux on passage of an electric current; and pole cores or segments 1 and 2 disposed so as to cover the field windings 3, magnetic poles being formed in the segments 1 and 2 by the magnetic flux generated by the field windings 3. The end and center segments 1 and 2, respectively, are preferably made of iron, each end segment 1 having two first and second claw-shaped magnetic poles 30 and 32, respectively, disposed on an outer circumferential edge and aligned with each other in a circumferential direction so as to project axially, and the end segment pole cores 30 and 32 are fixed to the shaft 14 facing each other such that the center segment core is therebetween the claw-shaped end segment magnetic poles 30 and 32 and intermesh with the magnetic poles 33 and 35 of center segment 2, respectively, as best seen in FIG. 2.

Still referring to FIG. 1, fans 34 and 36 (internal fans) are fixed to first and second axial ends of the rotor assembly 100. Front-end and rear-end air intake apertures (not shown) are disposed in axial end surfaces of the front bracket 18 and the rear bracket 20, and front-end and rear-end air discharge apertures (not shown) are disposed in first and second outer circumferential portions of the front bracket 18 and the rear bracket 20 preferably radially outside front-end and rear-end coil end groups of the armature winding 38 installed in the stator core 4.

In the dynamoelectric machine 200 constructed in this manner, an electric current is supplied to the twin field windings 3 from the storage battery through the brushes 26 and the slip rings 24, generating a magnetic flux. The first claw-shaped magnetic poles 30 and 32 of the end segments 1 are magnetized into a fixed polarity by this magnetic flux (such as North seeking (N) poles), and the center claw-shaped magnetic poles 33 and 35 are magnetized into the opposite polarity (such as South-seeking (S) poles). At the same time, rotational torque from the engine is transmitted to the shaft 14 by means of the belt (not shown) and the pulley 22, rotating the rotor assembly 100. Thus, a rotating magnetic field is imparted to the armature winding 38, inducing a voltage across the armature winding 38.

Referring now to FIG. 3, the dynamoelectric machine 200 is illustrated as a circuit diagram. This alternating-current electromotive force passes through rectifier 40 and is converted into direct current, the magnitude thereof is adjusted by the voltage regulator (not shown), a storage battery 42 is charged, and the current is supplied to an electrical load 44.

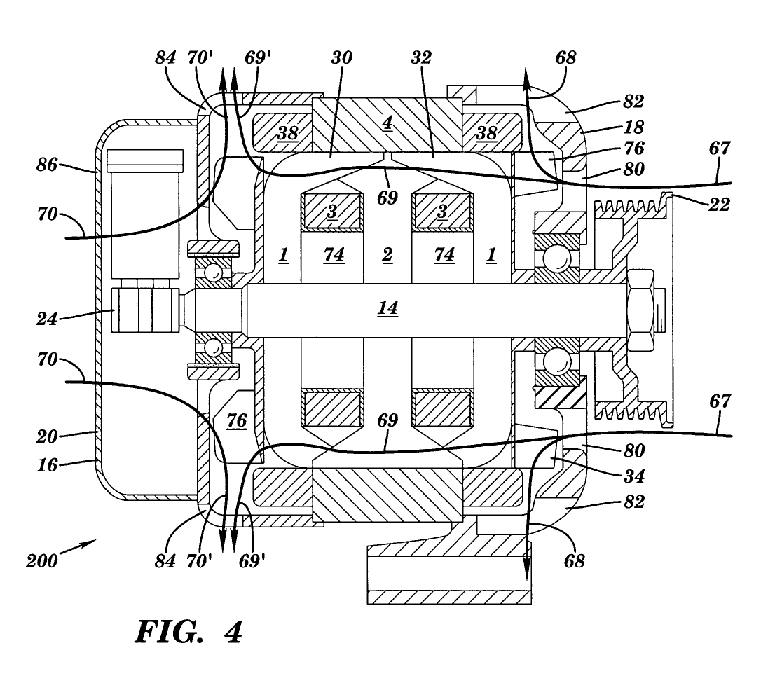

Along with the electrical load escalation, is a continuing customer demand for lower emitted noise. To address the mechanical noise emitted from the dynamoelectric machine 200 or alternator depicted in FIG. 1 and reproduced in FIG. 4, the cooling arrangement thereof includes a dual internal fan configuration, (i.e., fans 34 and 36). With this configuration one fan 34 is placed on the drive end side of the rotor assembly 100 and the other fan 36 is placed on the slip ring end (SRE) side of the rotor assembly 100. These fans 34, 36 are located within the housing 16 of the alternator 200 and hence the dual internal fan designation. By virtue of this design and the housing 16 inlet/outlet design, the drive end fan 34 pulls air axially into the alternator 200 generally shown with arrows 67. At the drive end fan 36 location, this flow splits and part of the air is exhausted primarily in a radial direction indicated with arrows 68 while another part of the flow continues in an axial direction 69 and then exits out on the opposite side of the stator 4 on the SRE side generally shown at 69′. On the SRE side proximate slip rings 24, air is drawn axially into the back of the alternator 200 by the second fan 36 in an axial direction indicated generally with arrows 70 and then exhausts primarily in a radial direction indicated generally with arrows 70′.

One aspect of this disclosure is to combine the two elements described above, namely the claw pole rotor 100 with three segments (i.e., pair of opposing end segments 1 and center segment 2) and dual internal fan configuration 34 and 36, into one common electrical machine. In this fashion, the dynamoelectric machine 200 will have higher output current capability with reduced mechanical air noise. In an exemplary embodiment, the dynamoelectric machine 200 is an alternating current (AC) generator having a field rotor composed of more than two flux carrying segments 1, 2 with each segment having P/2 claw poles where P is an even number and a rotor assembly 100 having two fans located adjacent to, but outside of the outermost or outbound flux carrying segments 1 of the field rotor and opposite each other, and mounted concentric with the rotor shaft internal to the alternator housing.

Another technical aspect realized by the present disclosure is that the three segment claw pole rotor with dual fans significantly increases output and reduces mechanical air flow noise at a cost significantly less than the alternatives for the same increase in output and efficiency, for example, such as the alternative of liquid cooling the alternator to reduce the air flow rate required by the fans.

The present dual internal fan configuration described above diminishes the airflow noise without reducing airflow to an undesirable level. With regard to the operation of the alternating current generator of the above construction, when the rotor 100 is rotated by an external driving force via pulley 22, a magnetic field generated by the pair of field windings 3 surrounding field cores 74, and the magnetic field passes through the stator winding 38 in conformance with the rotation of the rotor 100. In this manner, current is generated in the stator winding 38 and a power is generated through rectifier 40.

Furthermore, when the rotor 100 is rotated, fans 34, 36 fixed to the shaft 14 are rotated together with the field cores 74, and blades 76 defining cut-raised portions extending from fans 34, 36, are also rotated to produce air flow inside the dynamoelectric machine 200.

The air flows may be principally divided into flows 67, 68, 69, and 69′ or flows 70 and 70′ as described above. Flows 67, 68, 69, and 69′ represent air flowing in through an inlet port 80 of front bracket 18, passing through the coil end of the stator winding 38, and splitting to exhaust primarily in a radial direction (i.e., 68) out of an outlet port 82 of the front bracket 18 and remaining portion of air flow continuing in an axial direction (i.e., 69) flowing out through an outlet port 84 of the rear bracket 16.

Flows 70 and 70′ represent air flowing in through an inlet port 86 of rear bracket 16, passing through the rectifier 40 (FIG. 3) and brush 26, and flowing out through outlet port 84 of rear bracket 16. The inside of the dynamoelectric machine 200 is cooled by these air flows.

Generally, the heat produced within the alternating current generator is dependent upon the losses within the alternator which is turn is dependent upon the output. Whereas the cooling air flow rate produced by a cooling fan is increased in proportion to the rpm while the wind noise is also increased. In this regard, the temperature rise value of every part inside the dynamoelectric machine cooled by the cooling fan is dependent upon a relation between the output and air flow rate. By combining a claw pole rotor having three segments with a dual internal fan configuration into one common electrical machine, output current capability is increased while emitted air noise is decreased. Furthermore, such an arrangement for the field rotor (i.e., claw pole with three segments) produces a stronger rotating magnetic field and allows an axial length of the stator to be more effectively lengthened.

The technical benefits realized by this invention allow for significant increases in current output and a reduction in mechanical air flow noise at a cost significantly less than the alternatives for the same increase in output and efficiency. More specifically, alternatives include adding magnets between the claw poles of the rotor or hairpin stator windings. Mechanical noise can be reduced by liquid cooling the alternator to reduce the air flow rate required by the fans and hence reduce their size or possibly even eliminate them totally. However, such alternatives for the same increase in output and efficiency in accordance with exemplary embodiments described herein cost significantly more.

While the exemplary twin coil claw pole rotor and dual internal fan configuration has been described for use with generators associated with vehicles, the same may also be used and incorporated in applications other than generators for a vehicle where enhancement in electrical generation efficiency and reduction of emitted air noise is desired.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A dynamoelectric machine comprising:
a housing defining a drive end and an opposite slip ring end;
a stator;
a rotor rotatable within said stator, said rotor including more than two flux carrying segments rotatably disposed on a rotor shaft in said housing, each segment having P/2 claw poles, wherein P is an even number; and
a rotor assembly including two fans located adjacent to outbound segments defining said rotor and opposite each other disposed inside said housing and mounted concentric with said rotor shaft.

2. The machine of claim 1, wherein said two fans include a drive end fan and a slip ring end fan disposed at said drive end and said slip ring end, respectively, said drive end fan configured to axially draw drive end air into said drive end, said slip ring end fan configured to axially draw slip ring end air into said slip ring end.

3. The machine of claim 2, wherein said drive end is configured to exhaust a first portion of said drive end air radially out of said housing on a first side of said stator corresponding to said drive end, while a second portion of said drive end air is diverted axially through said stator and radially exhausted from said housing on an opposite second side of said stator corresponding to said slip ring end.

4. The machine of claim 3, wherein said slip ring end is configured to exhaust said slip ring end air radially out of said housing on said opposite second side of said stator corresponding to said slip ring end.

5. The machine of claim 1, wherein a coil winding is disposed intermediate each of said more than two flux carrying segments.

6. The machine of claim 5, wherein each coil winding is energized providing a first magnetic polarity on outbound claw poles defining said rotor and a second polarity opposite said first polarity on claw poles intermediate said outbound claw poles.

7. The machine of claim 1, wherein permanent magnets are disposed between said each segment to enhance at least one of output and efficiency.

8. An alternating current (AC) generator for a motor vehicle comprising:
a housing defining a drive end and an opposite slip ring end;
a stator;
a field rotor rotatable within said stator, said rotor including more than two flux carrying segments rotatably disposed on a rotor shaft in said housing, each segment having P/2 claw poles, wherein P is an even number; and
a rotor assembly including two fans located adjacent to outbound segments defining said rotor and opposite each other disposed inside said housing and mounted concentric with said rotor shaft.

9. The generator of claim 8, wherein said two fans include a drive end fan and a slip ring end fan disposed at said drive end and said slip ring end, respectively, said drive end fan configured to axially draw drive end air into said drive end, said slip ring end fan configured to axially draw slip ring end air into said slip ring end.

10. The generator of claim 9, wherein said drive end is configured to exhaust a first portion of said drive end air radially out of said housing on a first side of said stator corresponding to said drive end, while a second portion of said drive end air is diverted axially through said stator and radially exhausted from said housing on an opposite second side of said stator corresponding to said slip ring end.

11. The generator of claim 10, wherein said slip ring end is configured to exhaust said slip ring end air radially out of said housing on said opposite second side of said stator corresponding to said slip ring end.

12. The generator of claim 8, wherein a coil winding is disposed intermediate each of said more than two flux carrying segments.

13. The generator of claim 12, wherein each coil winding is energized providing a first magnetic polarity on outbound claw poles defining said rotor and a second polarity opposite said first polarity on claw poles intermediate said outbound claw poles.

14. The generator of claim 8, wherein permanent magnets are disposed between said each segment to enhance at least one of output and efficiency.
